(19) United States
(12) Patent Application Publication
(10) Pub. No.: US 2018/0189249 A1
(43) Pub. Date: Jul. 5, 2018

(54) PROVIDING APPLICATION BASED SUBTITLE FEATURES FOR PRESENTATION

(71) Applicant: Microsoft Technology Licensing, LLC, Redmond, WA (US)

(72) Inventors: Kelly R Berman, Redmond, WA (US); Ryan C Hill, Redmond, WA (US)

(73) Assignee: Microsoft Technology Licensing, LLC, Redmond, WA (US)

(21) Appl. No.: 15/398,160

(22) Filed: Jan. 4, 2017

(51) Int. Cl. G06F 17/24; G10L 15/26; G06F 17/28

(52) U.S. Cl. CPC G06F 17/24; H04L 67/42; G06F 17/289; G10L 15/265

(57) ABSTRACT

An application based subtitle features are provided for a presentation. A productivity application initiates operations to provide subtitle features upon receiving a subtitle input from a content creator. The subtitle input is detected as allocated for a slide of the presentation. Next, a subtitle is generated from the subtitle input for the slide. A presentation timing is determined for the subtitle. Furthermore, the subtitle is integrated with the slide based on the presentation timing. The slide is also presented with the subtitle during the presentation timing in response to a detected action to present the slide.

### BACKGROUND

Automation and improvements in processes have expanded scope of capabilities offered for personal and business consumption. With the development of faster and smaller electronics, providing elaborate features (that improve functionality) in content production have become feasible. Indeed, applications provided to generate and render content have become common features in modern personal and work environments. Such systems execute a wide variety of applications ranging from document productivity applications to process management applications.

Improved content presentation techniques are becoming ever more important as content production and presentation complexity increases across a variety of business, educational, and/or personal environments. Variety of techniques are necessary to render a presentation and record the presentation while rendering. There are currently significant gaps when attempting to render and/or record a presentation while generating subtitles for the presentation. Lack of relevant subtitle features in legacy application and/or content production environments lead to poor management of valuable resources when attempting to generate subtitles during content production for a presentation or while rendering the presentation.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to application based subtitle features for a presentation. A productivity application, according to embodiments, may initiate operations to provide subtitle features upon receiving a subtitle input from a content creator. The subtitle input may be detected as allocated for a slide of the presentation. Next, a subtitle may be generated from the subtitle input for the slide. A presentation timing may be determined for the subtitle. Furthermore, the subtitle may be integrated with the slide based on the presentation timing. The slide may also be presented with the subtitle during the presentation timing in response to a detected action to present the slide.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing application based subtitle features for a presentation, according to embodiments;

FIG. 2 is a display diagram illustrating example components of a productivity application that provides subtitle features for a presentation, according to embodiments;

FIG. 3 is a display diagram illustrating components of a scheme to provide application based subtitle features for a presentation, according to embodiments;

FIG. 4 is a display diagram illustrating an example of a user interface providing subtitle features for a presentation, according to embodiments;

FIG. 5 is a simplified networked environment, where a system according to embodiments may be implemented;

FIG. 6 is a block diagram of an example computing device, which may be used to provide application based subtitle features for a presentation, according to embodiments; and

FIG. 7 is a logic flow diagram illustrating a process for providing application based subtitle features for a presentation, according to embodiments.

### DETAILED DESCRIPTION

As briefly described above, a productivity application may provide subtitle features for a presentation. In an example scenario, the productivity application may receive a subtitle input from a content creator. The subtitle input may be detected as allocated for the slide of the presentation. The subtitle input may include a text based input and/or a voice based input. Next, a subtitle may be generated from the subtitle input for the slide. A voice based input may be converted to text by processing an audio stream captured from the voice based input. The text may be used to generate the subtitle.

A presentation timing may be determined for the subtitle. A text based input may be converted to an audio stream to determine the presentation timing of the subtitle. The length of the audio stream may be used as the presentation timing. Furthermore, the subtitle may be integrated with the slide based on the presentation timing. The subtitle may be saved into a metadata of the presentation in an association with the slide. The slide may be presented with the subtitle during the presentation timing in response to a detected action to present the slide.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide application based subtitle features for a presentation. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

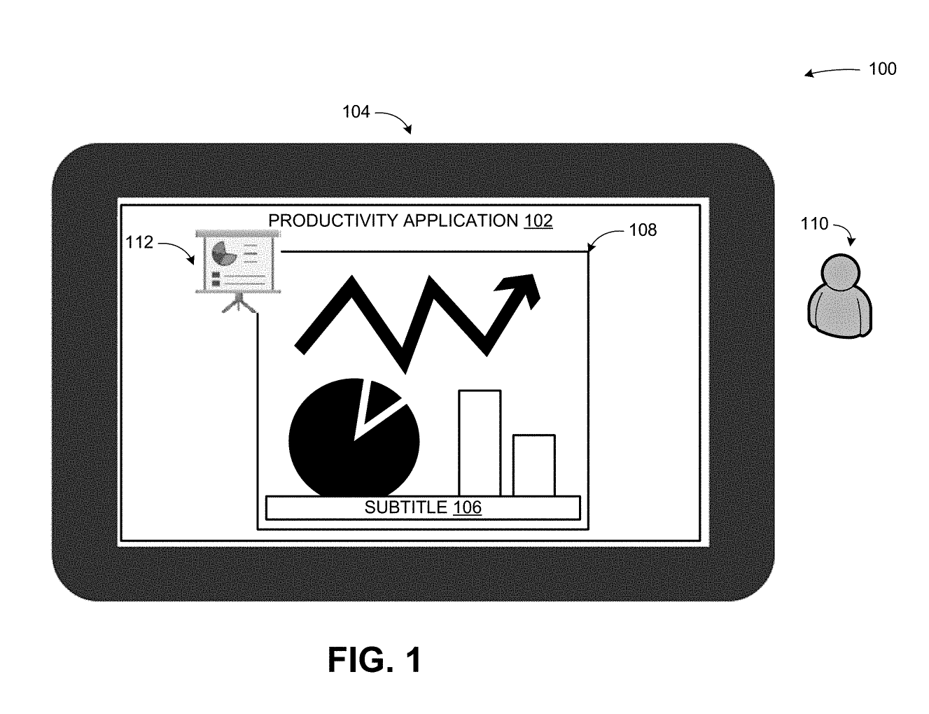

FIG. 1 is a conceptual diagram illustrating examples of providing application based subtitle features for a presentation, according to embodiments.

In a diagram 100, a computing device 104 may execute a productivity application 102. The computing device 104 may include a physical computer and/or a mobile computing device such as a smart phone and/or similar ones. The computing device 104 may also include a special purpose and/or configured device that is optimized to execute data operations associated with the productivity application 102. For example, the computing device 104 may include physical components that are custom built to accelerate subtitle production for a presentation 112 through computation core(s) tailored to manage subtitle production operations for the presentation 112.

The computing device 104 may execute the productivity application 102. The productivity application 102 may include a presentation application, a document processing application, and/or an application configured to present partitioned content, among others. The productivity application 102 may initiate operations to provide subtitle features upon receiving a subtitle input from a content creator 110. The content creator may include an entity that creates the presentation 112 (such as a presenter). The presentation 112 may include content that is partitioned to slides. A slide 108 may include text, graphic(s), image(s), a video stream, an audio stream, among others that make up the content of the presentation 112.

The subtitle input may be detected as allocated for the slide 108 of the presentation 112. The subtitle input may include a text based input and/or a voice based input. The text based input may be typed into the slide 108 by the content creator 110. Next, a subtitle 106 may be generated from the subtitle input, for the slide 108. The subtitle 106 may include line(s) of text that are typed on content of the slide 108. The typed text may be captured as the subtitle 106. A voice based input may be converted to text by processing an audio stream captured from the voice based input. The text may be used to generate the subtitle 106. An example of the subtitle 106 may include a closed captioned text.

A presentation timing may also be determined for the subtitle 106. A text based input may be converted to an audio stream to determine the presentation timing of the subtitle 106. The length of the audio stream may be used as the presentation timing. Furthermore, the subtitle 106 may be integrated with the slide based on the presentation timing. The subtitle may be saved into a metadata of the presentation 112 in an association with the slide 108. The slide 108 may be presented with the subtitle 106 during the presentation timing in response to a detected action to present the slide 108. Alternatively, a render time of the slide 108 and/or the subtitle 106 may not be limited to the presentation timing. The slide 108 and/or the subtitle 106 may be rendered indefinitely or during a rendering time as designated by the content creator 110 and/or the productivity application 102.

The subtitle 106 may be rendered overlaid on the slide 108 in proximity to (or within) a bottom section of the slide 108. However, a position of the subtitle 106 may alternatively be specified by the content creator 110 or a system setting. Object recognition schemes may also be used to position the subtitle 106 in an area of the slide 108 with few or no objects to prevent the subtitle 106 from hiding objects within the content of the slide 108.

The computing device 104 may communicate with other client device(s) or server(s) through a network. The network may provide wired or wireless communications between network nodes such as the computing device 104, other client device(s) and/or server(s), among others. Previous example(s) to provide subtitle features for the presentation 112 with the productivity application 102 are not provided in a limiting sense. Alternatively, the subtitle 106 may be generated by an application programming interface (API) and/or a third party application by processing subtitle input provided by the content creator 110. Standardized or special purpose APIs and objet models may be implemented to control the processing and exposure of subtitles. Furthermore, a service hosted by a physical server may provide a client interface such as the productivity application 102 that generates the subtitle 106 for rendering with the slide 108 at the computing device 104.

The content creator 110 may interact with the productivity application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 104, the productivity application 102, embodiments are not limited to these components or system configurations and can be implemented with other system configuration employing fewer or additional components.

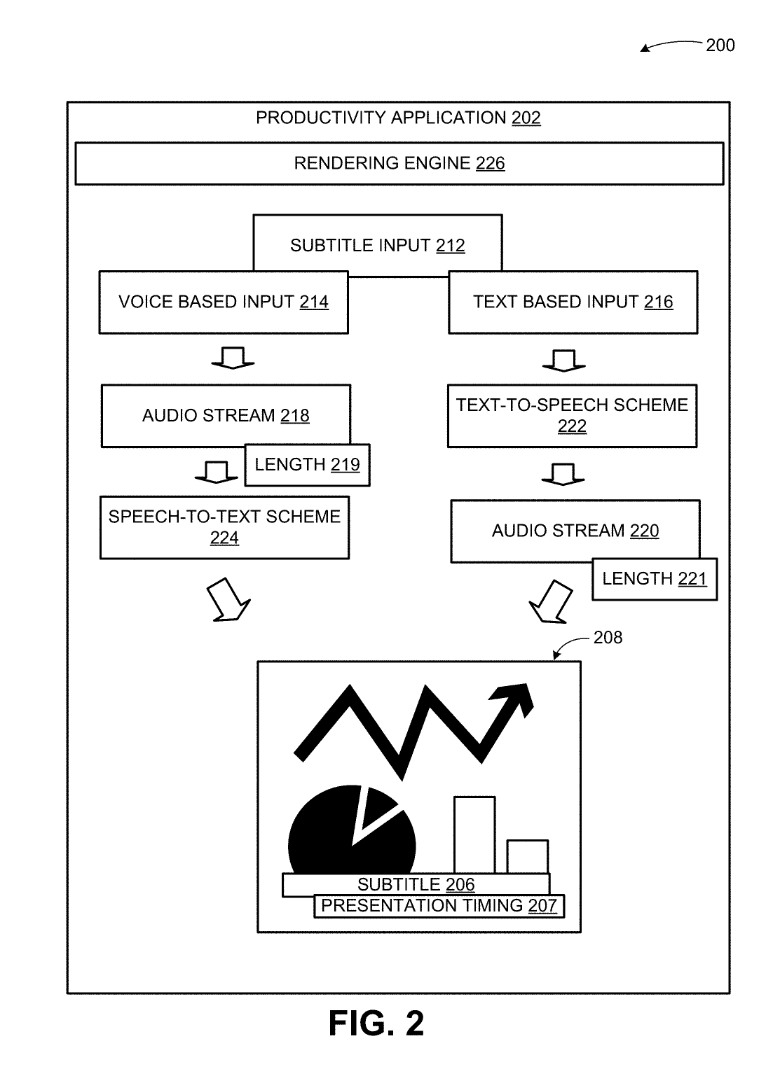

FIG. 2 is a display diagram illustrating example components of a productivity application that provides subtitle features for a presentation, according to embodiments.

In a diagram 200, a rendering engine 226 of a productivity application 202 may receive a subtitle input 212 from a content creator. The subtitle input may include a voice based input 214. An example of the voice based input 214 may include a captured dictation (provided by the content creator). The voice based input 214 may be captured in real time and converted into text for integration with a slide 208 as a subtitle 206. An example of the subtitle 206 may include a closed captioned text.

In an example scenario, the content creator may dictate the voice based input 214 in real time. The voice based input 214 (that is dictated) may be captured in an association with the slide 208 as an audio stream 218. A length 219 of the audio stream 218 may be designated as a presentation timing for the subtitle 206. The presentation timing may be used to define how long the slide 208 is rendered with the subtitle 206).

Alternatively, the content creator may provide a recording of a presentation from which to generate the subtitle 206. The recording may be processed to generate the subtitle 206. A section of the recording of the presentation allocated to the slide 208 may be extracted as the audio stream 218. The content creator may include markers in the recording to allocate the section of the recording to the slide 208. Furthermore, the productivity application 202 may process the recording of the presentation to identity the section as describing concepts that are related to the content presented by the slide 208. In such a scenario, the productivity application 202 may designate the section of the recording as allocated to the slide 208.

The length 219 of the audio stream 218 may be designated as the presentation timing 207 of the subtitle 206. For example, the productivity application 202 may present the slide 208 with the subtitle 206 during the presentation timing 207 upon a detected action to present the slide 208. The detected action may include a next slide action that moves the presentation from a previous slide to the slide 208. Alternatively, the detected action may include a start action to initiate rendering of the presentation with the slide 208.

The subtitle 206 may be generated from the audio stream 218 by processing the audio stream 218 with a text-to-speech scheme 224. The text-to-speech scheme 224 may convert the audio stream 218 to text. The text may include words, spaces, and/or grammatical characters to format the text as sentences, lines, and/or paragraphs among other grammatical structures. The text may be used to generate the subtitle 206. For example, the text may be formatted based on a subtitle standard such as an SRT (SubRip Subtitle file), a timed text markup language (TTML), and/or a web video text tracks (WVTT), among other standardized formats to generate the subtitle 206. The subtitle formatting standard may be selected by the content creator or by the productivity application 202 based on a system setting.

In another example scenario, the content creator may provide a text based input 216 as the subtitle input 212. For example, the content creator may type text into a section of the slide 208 that is reserved for subtitle creation features associated with the slide 208. The text may be used to generate the subtitle 206. The text may be formatted based on a subtitle formatting standard to generate the subtitle 206.

Presentation timing, for the subtitle 206 (generated from the text based input 216) may be computed automatically. For example, the rendering engine 226 of the productivity application 202 may process the text based input 216 through a text-to-speech scheme 222 to generate an audio stream 220. A length 221 of the audio stream 220 may be designated as the presentation timing 207 of the subtitle 206. The slide 208 may be rendered with the subtitle 206 during the presentation timing 207 (upon a detected action to present the slide 208). Upon an expiration of the presentation timing 207, the productivity application 202 may move the presentation to a next slide and/or stop rendering the subtitle 206 overlaid on the slide 208.

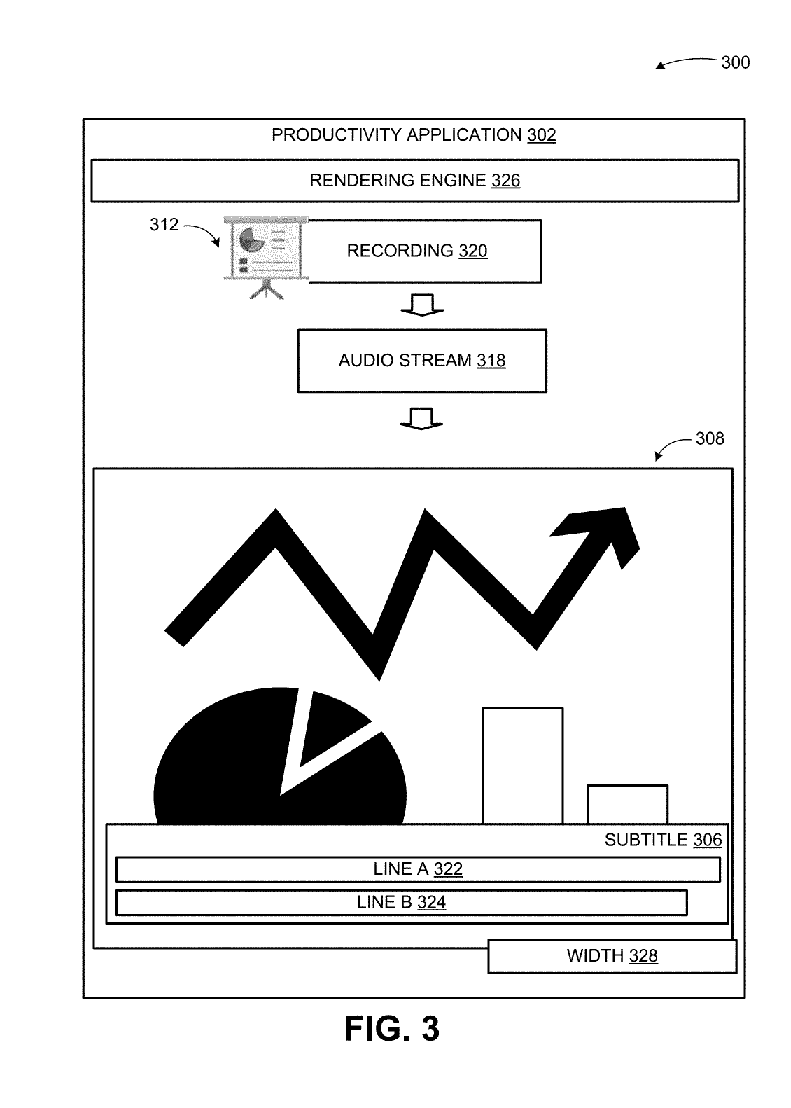

FIG. 3 is a display diagram illustrating components of a scheme to provide application based subtitle features for a presentation, according to embodiments.

In a diagram 300, a rendering engine 326 of the productivity application 302 may receive a recording 320 of a presentation 312. The recording 320 may include a video stream (with an audio stream) and/or an audio stream. The recording 320 may be processed to identify a section of the recording 320 allocated for a slide 308. The section of the recording 320 may be extracted as an audio stream 318 to be processed for subtitle production. Alternatively, the content creator may initiate operations to generate a subtitle 306 by dictating the audio stream 318 allocated for the slide 308. The audio stream 318 may be captured in the recording 320. Furthermore, the content creator may enter text into the slide 308 to be converted into the subtitle 306.

A length of the audio stream 318 may be measured and captured as a presentation timing for the subtitle 306. For example, the slide 308 may be rendered with the subtitle 306 during the presentation timing (upon a detected action to present the slide 308). The audio stream 318 extracted from the recording 320 may be processed with a speech-to-text scheme to convert the audio stream 318 to text. The text may be used to generate the subtitle 306. For example, a line A 322 and a line B 324 may be generated from the text, based on a font size (and/or font type) of the subtitle 306 and a width 328 of the slide 308. The font size of the subtitle 306 may be selected by the content creator or configured based on a default system setting. The font size of the font style of the subtitle 306 may be restricted based on subtitle formatting standard chosen to create the subtitle 306.

A number of computations may be executed to determine a size of the lines A and B (322 and 324). For example, a maximum character count may be computed for a number of characters that fit the width 328 of the slide based on the font size of the subtitle 306. In an example scenario, the text (extracted from the audio stream 318) may be partitioned to word(s). The word(s) may be detected by a pattern recognition scheme based on spacing and punctuation characters between each word of the text. A subset of the word(s) may be inserted into the line A 322 and a remaining subset of the word(s) may be inserted into the line B 324 of the subtitle 306. The productivity application 302 may insert a subset of the word(s) of the text into the line A 322 while a character count for the line A 322 does not exceed the maximum character count. A remaining subset of the word(s) of the text (extracted from the audio stream 318) may be inserted into the line B 324 while a character count for the line B 324 does not exceed the maximum character count. If the lines A and B (322 and 324) are insufficient to encapsulate the text (of the subtitle input), the productivity application 302 may create new lines of the subtitle 306 until all words of the text are encapsulated by the subtitle 306.

The productivity application 302 may also count a number of the lines A and B (322 and 324). A line timing (to render the lines A and/or B (322 and/or 324)) may be computed by dividing the presentation timing with the number of the lines A and B (322 and 324). Alternatively, instead of using an averaging scheme to determine the line timing to render the lines A and/or B (322 and/or 324), the productivity application 302 may partition the presentation timing of the subtitle 306 based on where in the audio stream 318 a content of the line A 322 ends and a content of the line B 324 begins. In such a scenario, word(s) and/or sentence(s) that take shorter and/or longer time to speak may be rendered for a shorter and/or a longer time through the lines A and/or B (322 and/or 324) which may reflect an improved speech timing compared to an averaging scheme.

Furthermore, the productivity application 302 may identify a maximum line count for the subtitle 306. The maximum line count may be a value provided by the content creator to prevent a high number of lines to be rendered within the subtitle 306 and obscure an excessive amount of content presented by the slide 308. Alternatively, the productivity application 302 may configure the maximum line count based on a default system setting.

Upon detecting the number of the lines A and B (322 and 324) to exceed the maximum line count, the productivity application 302 may render the lines in a scroll through scheme in which each of the lines A and B (322 and 324) are rendered on the slide 308 within the line timing previously computed. Each of the lines A and B (322 and 324) are overlaid on the slide 308 during a period that equals the maximum line count multiplied by the line timing. For example, if the maximum line count is 1 for the subtitle 306, the line A 322 is rendered during a line timing as the subtitle 306 overlaid on the slide 308. Upon an expiration of the line timing, the line A 322 is removed and the line B 324 is rendered as the subtitle 306 overlaid on the slide 308 during the line timing. A transition from the line A 322 to the line B 324 may be rendered instantaneously or through an animated rendering such as an animation in which the line B 324 moves gradually to replace the line A 322.

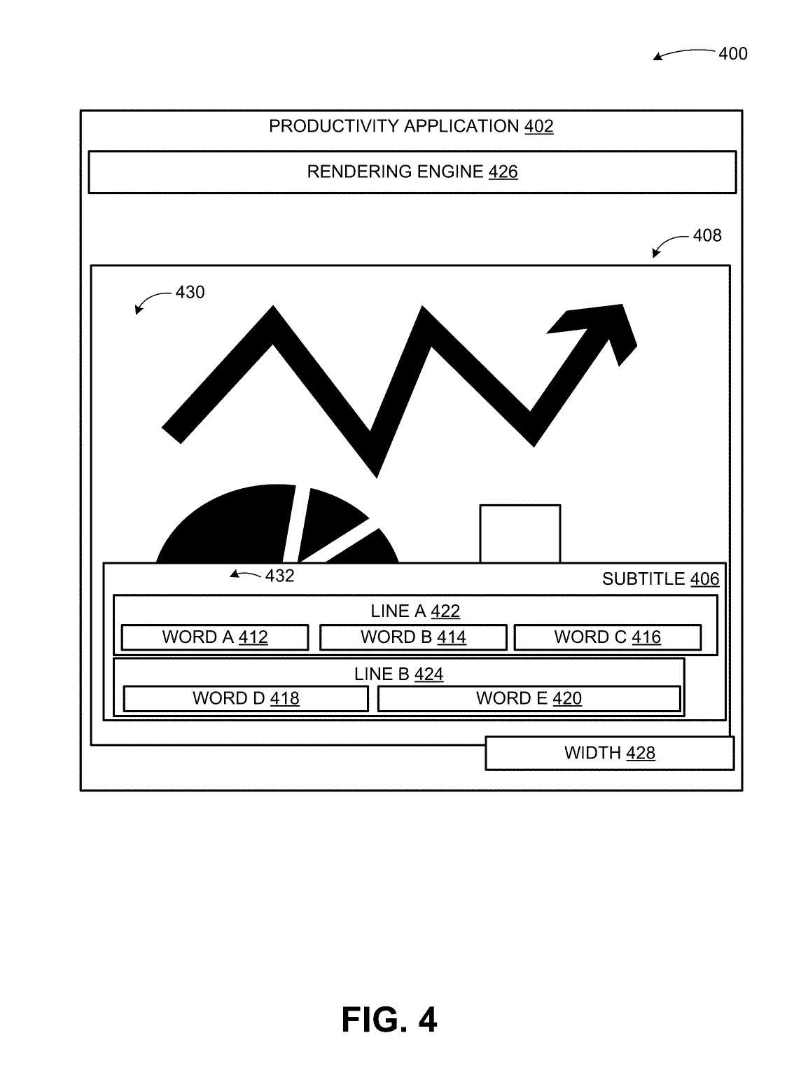

FIG. 4 is a display diagram illustrating an example of a user interface providing subtitle features for a presentation, according to embodiments.

In a diagram 400, a rendering engine 426 of a productivity application 402 may render a subtitle 406 overlaid on a slide 408 of a presentation. The subtitle 406 may be extracted from a subtitle input (provided by a content creator). The subtitle 406 may be rendered as a line A 422 and a line B 424 of text of the subtitle input. Each of the lines A and B (422 and 424) may be partitioned based on word(s) of the text of the subtitle input. For example, the line A 422 may include words A, B, and C (412, 414, and 416) with a character count that does not exceed a maximum character count that fits a width 428 of the slide 408. Remaining text of the subtitle input may be partitioned as words D and E (418 and 420) inserted into the line B 424 of the subtitle 406.

In an example scenario, the subtitle 406 may be saved as an initial subtitle track of the presentation within a metadata of the presentation. As such, the productivity application 402 and/or another application may access and process the metadata to render the subtitle 406 within the slide 408. Alternatively, the subtitle 406 may be embedded into the slide 408 and the presentation may be saved with the subtitle 406 embedded in the slide 408.

In another example scenario, the productivity application 402 may detect an intent of the creator (in response to one or more instructions) to save localized subtitle track(s) of the presentation. In such a scenario, the subtitle 406 may be translated to localized subtitle(s). The translation may be done by the productivity application 402 or delegated to a localization application and/or module. The localized subtitle(s) may be saved as localized subtitle track(s) in an association with the slide 408 within metadata of the presentation (or as embedded into the slide 408).

The productivity application 402 may also update a recording of the presentation to display the slide 408 with the subtitle 406. For example, a section of a video stream (as the recording) that corresponds to the slide 408 may be reprocessed to display the slide 408 with the subtitle 406. Furthermore, upon detecting a silent section within an audio stream (processed for subtitle production), an empty line may be inserted into the subtitle in a location that corresponds to the silent section within the audio stream. The line timing to render the empty line may be matched to a length of the silent section. Alternatively, the productivity application 402 may remove silent section(s) of an audio stream at a beginning and/or an end of the audio stream prior to processing the audio stream to generate the subtitle 406.

The productivity application 402 may also select a background color 432 for the subtitle 406 based on a background color 430 of the slide 408. For example, the background color 432 for the subtitle 406 may be selected such that the background color 432 contrasts from the background color 430 of the slide 408 (for example choosing a white background color for the background color 432 upon detecting the background color 430 as black). The background color 432 of the subtitle 406 is selected to contrast from the background color 430 of the slide 408 to improve visibility of the subtitle 406.

Similarly, a font color of the subtitle 406 is selected to contrast from a font color of text based content of the slide 408 to improve visibility of the subtitle 406. If the slide 408 does not include any text based content, then the productivity application 402 may choose a default (or content creator designated) font color for the subtitle 406. Furthermore, if the text based content of the slide 408 includes multiple font colors, the productivity application 402 may designate an average color (computed from color values of the text based content) as the font color for the text based content of the slide 408. Then, the productivity application 402 may designate a color that contrasts the average color as the font color for the subtitle 406.

In another example scenario, the subtitle 406 may be generated automatically from the content of the slide 408. The productivity application 402 (or a module) may recognize concepts and relationships from the text based content and/or other content presented in the slide 408 and generate the subtitle 406 from the concepts and relationships described by the text based content and/or other content of the slide 408.

As discussed above, the productivity application 102 may be employed to provide subtitle features for a presentation. An increased user efficiency with the productivity application 102 may occur as a result of automatically generating subtitles from subtitle input provided by a content creator and/or from a recording of the presentation. Automatically formatting a text of the subtitle input (or the recording) based on a subtitle formatting standard and rendering the subtitle during a presentation timing by the productivity application 102, may reduce processor load, increase processing speed, conserve memory, and reduce network bandwidth usage.

Embodiments, as described herein,, address a need that arises from a lack of efficiency to provide application based subtitle features for a presentation. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing application based subtitle features for a presentation may be implemented in configurations employing fewer or additional components in applications and user interfaces. Furthermore, the example schema and components shown in FIG. 1 through 4 and their subcomponents may be implemented in a similar manner with other values using the principles described herein.

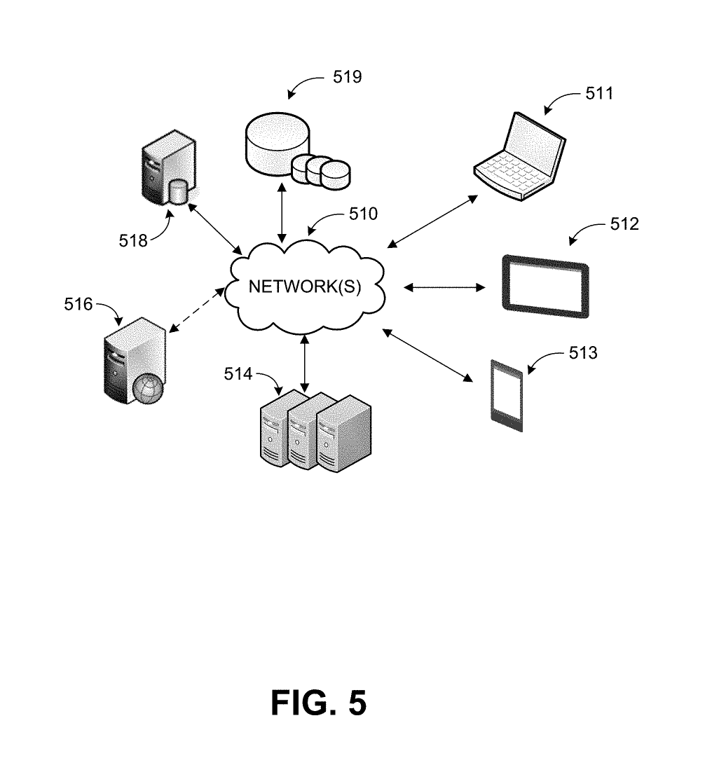

FIG. 5 is an example networked environment, where embodiments may be implemented. A productivity application configured to provide subtitle features for a presentation may be implemented via software executed over one or more servers 514 such as a hosted service. The platform may communicate with client applications on individual computing devices such as a smart phone 513, a mobile computer 312, or desktop computer 511 (‘client devices’) through network(s) 510.

Client applications executed on any of the client devices 511-513 may facilitate communications via application(s) executed by servers 514, or on individual server 516. A productivity application may receive a subtitle input allocated for a slide of a presentation from a content creator. Next, a subtitle may be generated from the subtitle input for the slide. A presentation timing may be determined for the subtitle. Furthermore, the subtitle may be integrated with the slide based on the presentation timing. The slide may also be presented with the subtitle during the presentation timing. The productivity application may store data associated with the slide and the subtitle in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide application based subtitle features for a presentation. Furthermore, the networked environments discussed in FIG. 5 are for illustration purposes only. Embodiments are not limited to the example applications, modules, or processes.

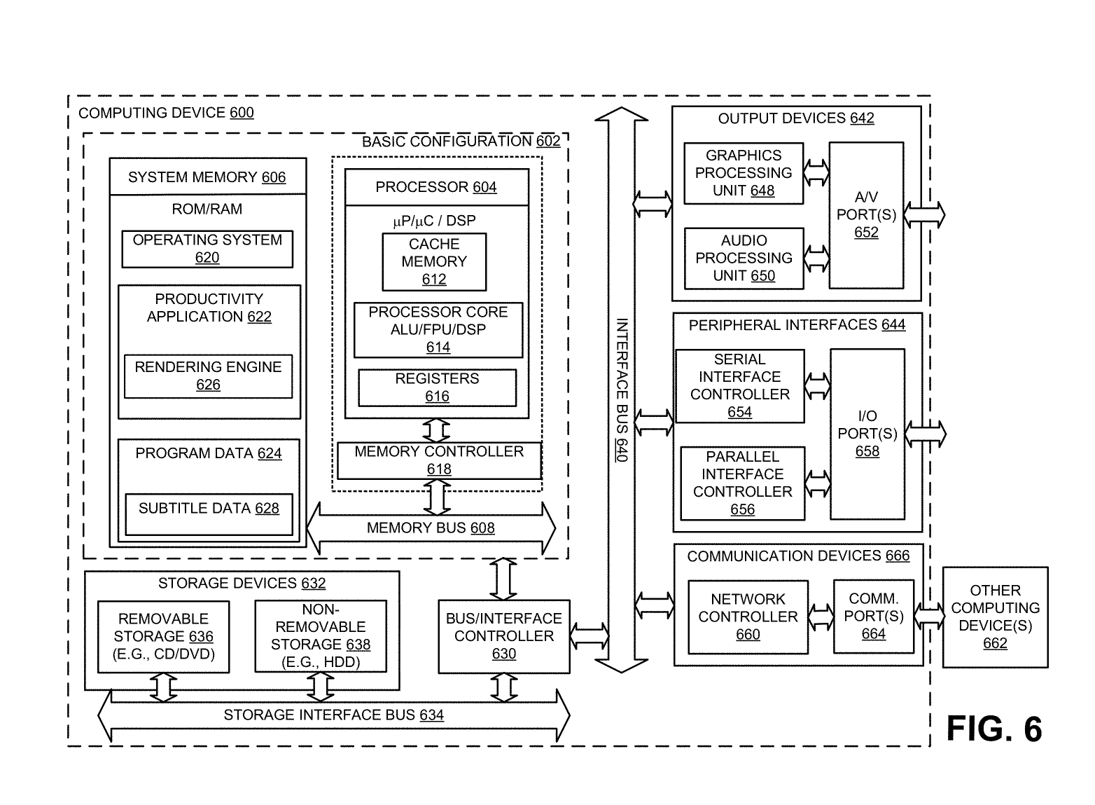

FIG. 6 is a block diagram of an example computing device, which may be used to provide application based subtitle features for a presentation, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity application 622, and a program data 624. The productivity application 622 may include components such as a rendering engine 626. The rendering engine 626 may execute the processes associated with the productivity application 622. The rendering engine 626 may receive a subtitle input allocated for a slide of a presentation from a content creator. Next, a subtitle may be generated from the subtitle input for the slide. A presentation timing may be determined for the subtitle. Furthermore, the subtitle may be integrated with the slide based on the presentation timing. The slide may also be presented with the subtitle during the presentation timing in response to a detected action to present the slide.

The productivity application 622 may render the subtitle overlaid on the slide within a presentation time through a display component associated with the computing device 600. An example of the display component may include a monitor, and/or a touch screen, among others that may be communicatively coupled to the computing device 600. The program data 624 may also include, among other data, subtitle data 628, or the like, as described herein. The subtitle data 628 may include line(s) of test generated as the subtitle from the subtitle input by the content creator.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices,, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide application based subtitle features for a presentation. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

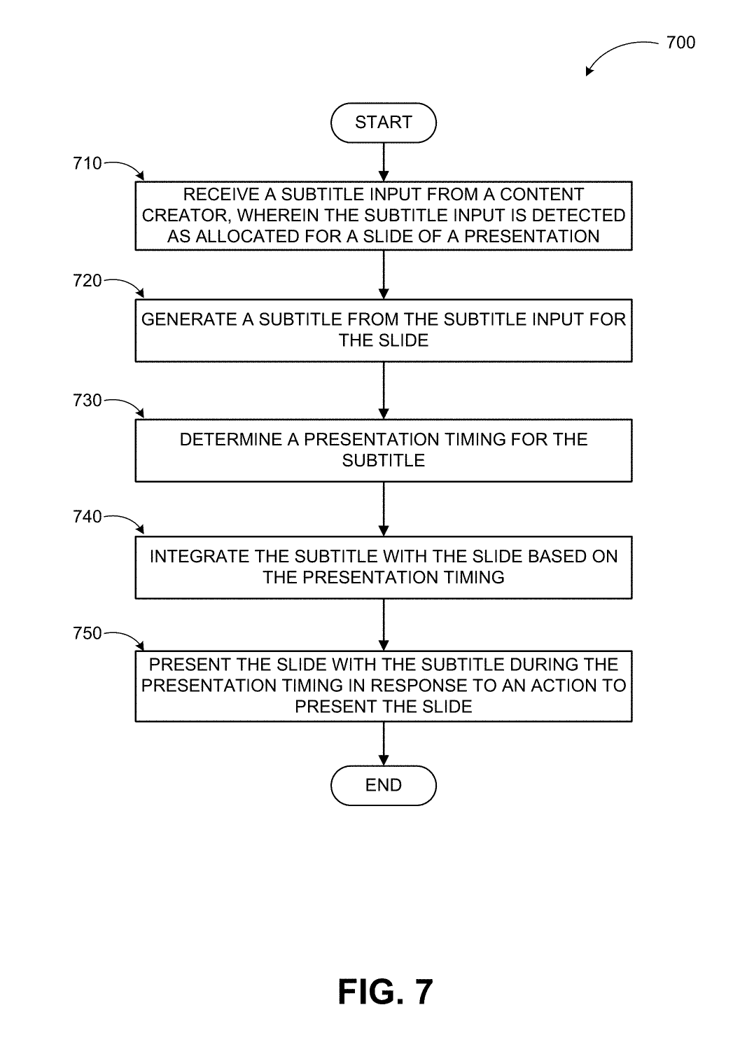

FIG. 7 is a logic flow diagram illustrating a process for providing application based subtitle feature for a presentation, according to embodiments. Process 700 may be implemented on a computing device, such as the computing device 600 or another system.

Process 700 begins with operation 710, where the productivity application receives a subtitle input from a content creator. The subtitle input may be detected as allocated for the slide of the presentation. The subtitle input may include a text based input and/or a voice based input. Next, at operation 720, a subtitle may be generated from the subtitle input for the slide. A voice based input may be converted to text by processing an audio stream captured from the voice based input through a speech-to-text scheme. The text may be used to generate the subtitle.

A presentation timing may be determined for the subtitle at operation 730. A text based input may be converted to an audio stream (through a text-to-speech scheme) to determine the presentation timing of the subtitle. The length of the audio stream may be used as the presentation timing. Furthermore, at operation 740, the subtitle may be integrated with the slide based on the presentation timing. The subtitle may be saved into a metadata of the presentation in an association with the slide. At operation 750, the slide may be presented with the subtitle during the presentation timing in response to a detected action to present the slide.

The operations included in process 700 is for illustration purposes. Providing an application based subtitle features for a presentation may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples a computing device to provide application based subtitle features for a presentation is described. The computing device includes a display component, a memory configured to store instructions associated with a productivity application, and a processor coupled to the memory and the display component. The processor executes the productivity application in conjunction with the instructions stored in the memory. The productivity application includes a rendering engine. The rendering engine is configured to receive a subtitle input from a content creator, where the subtitle input is detected as allocated for a slide of a presentation, generate a subtitle from the subtitle input for the slide, determine a presentation timing for the subtitle, integrate the subtitle with the slide based on the presentation timing, and present, on the display component, the slide with the subtitle during the presentation timing in response to a detected action to present the slide.

In other examples, the rendering engine is further configured to identity the subtitle input as a text based input and convert the text based input into an audio stream by processing the text based input with a text-to-speech scheme. The rendering engine is further configured to detect a length of the audio stream and designate the length of the audio stream as the presentation timing for the subtitle. The rendering engine is further configured to identify the subtitle input as a voice based input, capture the voice based input as an audio stream, and convert the audio stream into the subtitle by processing the audio stream with a speech-to-text based scheme.

In further examples, the rendering engine is further configured to generate one or more lines from the subtitle input based on a font size of the subtitle and a width of the slide. The rendering engine is further configured to compute a maximum character count for a number of characters that fit the width of the slide based on the font size of the subtitle, partition a text of the subtitle input to one or more words, and insert a subset of the one or more words to each of the one or more lines, where a line character count for the subset of the one or more words does not exceed the maximum character count. The rendering engine is further configured to count a number of the one or more lines, compute a line timing by dividing the presentation timing with the number of the one or more lines, and present, on the display component, each of the one or more lines during the line timing.

In other examples, the rendering engine is further configured to identify a maximum line count for the subtitle, detect the number of the one or more lines exceed the maximum line count, and scroll through, on the display component, each of the one or more lines during the line timing. Each of the one or more lines are overlaid on the slide during a period that equals the maximum line count multiplied by the line timing. The rendering engine is further configured to automatically format the subtitle based one or more of: an SRT (SubRip Text), a timed text markup language (TTML), and a web video text tracks (WVTT) format based on one or more of a default setting and a selection by the content creator.

In some examples, a method executed on a computing device to provide application based subtitle features for a presentation is described. The method includes extracting an audio stream allocated for a slide of a presentation by processing a recording of the presentation, generating a subtitle from the audio stream for the slide by converting the audio stream into the subtitle using a speech-to-text scheme, designating a length of the audio stream as a presentation timing for the subtitle, integrating the subtitle with the slide based on the presentation timing, and presenting the slide with the subtitle during the presentation timing in response to a detected action to present the slide.

In other examples, the method further includes saving the subtitle as an initial subtitle track of the presentation within a metadata of the presentation. The method further includes detecting an intent of a content creator to save one or more localized subtitle tracks of the presentation, translating the subtitle to one or more localized subtitles based on the intent of the content creator, and saving the one or more localized subtitles as the one or more localized subtitle tracks within the metadata of the presentation. The method further includes updating the recording of the presentation for rendering the slide with the subtitle.

In further examples, the method further includes detecting a silent section within the audio stream and inserting an empty line into the subtitle in a location that corresponds to the silent section within the audio stream. The method further includes detecting an action to display a next slide, discontinuing a rendering of the slide with the subtitle, generating a next subtitle for the next slide, and presenting the next slide with the next subtitle.

In some examples, a computer-readable memory device with instructions stored thereon to provide application based subtitle features for a presentation is described. The instructions include actions similar to the actions of the method.

In other examples, the instructions further include detecting a background color of the slide and selecting a background color for the subtitle, where the background color for the subtitle contrasts from the background color of the slide. The instructions further include detecting a font color of the slide and selecting font color for the subtitle, where the font color for the subtitle contrasts from the font color of the slide.

In some examples a means for providing application based subtitle features for a presentation is described. The means for means for providing application based subtitle features for a presentation includes a means for receiving a subtitle input from a content creator, where the subtitle input is detected as allocated for a slide of a presentation, a means for generating a subtitle from the subtitle input for the slide, a means for determining a presentation timing for the subtitle, a means for integrating the subtitle with the slide based on the presentation timing, and a means for presenting the slide with the subtitle during the presentation timing in response to a detected action to present the slide.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide application based subtitle features for a presentation, the computing device comprising:
a display component;
a memory configured to store instructions associated with a productivity application;
a processor coupled to the memory and the display component, the processor executing the productivity application in conjunction with the instructions stored in the memory, wherein the productivity application includes:
a rendering engine configured to:
receive a subtitle input from a content creator, wherein the subtitle input is detected as allocated for a slide of a presentation;
generate a subtitle from the subtitle input for the slide;
determine a presentation timing for the subtitle;
integrate the subtitle with the slide based on the presentation timing; and
present, on the display component, the slide with the subtitle during the presentation timing in response to a detected action to present the slide.

2. The computing device of claim 1, wherein the rendering engine is further configured to:
identify the subtitle input as a text based input; and
convert the text based input into an audio stream by processing the text based input with a text-to-speech scheme.

3. The computing device of claim 2, wherein the rendering engine is further configured to:
detect a length of the audio stream; and
designate the length of the audio stream as the presentation timing for the subtitle.

4. The computing device of claim 1, wherein the rendering engine is further configured to:
identify the subtitle input as a voice based input;
capture the voice based input as an audio stream; and
convert the audio stream into the subtitle by processing the audio stream with a speech-to-text based scheme.

5. The computing device of claim 1, wherein the rendering engine is further configured to:
identify a silent section at one or more of a beginning and an end of the audio stream;
generate a processed audio stream by removing the silent section at the one or more of the beginning and the end of the audio stream;
detect a length of the processed audio stream; and
designate the length of the processed audio stream as the presentation timing.

6. The computing device of claim 1, wherein the rendering engine is further configured to:
generate one or more lines from the subtitle input based on a font size of the subtitle and a width of the slide.

7. The computing device of claim 6, wherein the rendering engine is further configured to:
compute a maximum character count for a number of characters that fit the width of the slide based on the font size of the subtitle;
partition a text of the subtitle input to one or more words; and
insert a subset of the one or more words to each of the one or more lines, wherein a line character count for the subset of the one or more words does not exceed the maximum character count.

8. The computing device of claim 6, wherein the rendering engine is further configured to:
count a number of the one or more lines;
compute a line timing by dividing the presentation timing with the number of the one or more lines; and
present, on the display component, each of the one or more lines during the line timing.

9. The computing device of claim 8, wherein the rendering engine is further configured to:
identify a maximum line count for the subtitle;
detect the number of the one or more lines exceed the maximum line count; and
scroll through, on the display component, each of the one or more lines during the line timing.

10. The computing device of claim 9, wherein each of the one or more lines are overlaid on the slide during a period that equals the maximum line count multiplied by the line timing.

11. The computing device of claim 1, wherein the rendering engine is further configured to:
automatically format the subtitle based one or more of: an SRT, a timed text markup language (TTML), and a web video text tracks (WVTT) format based on one or more of a default setting and a selection by the content creator.

12. A. method executed on a computing device to provide application based subtitle features for a presentation, the method comprising;
extracting an audio stream allocated for a slide of a presentation by processing a recording of the presentation;
generating a subtitle from the audio stream for the slide by converting the audio stream into the subtitle using a speech-to-text scheme;
designating a length of the audio stream as a presentation timing for the subtitle;
integrating the subtitle with the slide based on the presentation timing; and
presenting the slide with the subtitle during the presentation timing in response to a detected action to present the slide.

13. The method of claim 12, further comprising:
saving the subtitle as an initial subtitle track of the presentation within a metadata of the presentation.

14. The method of claim 13, further comprising:
detecting an intent of a content creator to save one or more localized subtitle tracks of the presentation;
translating the subtitle to one or more localized subtitles based on the intent of the content creator; and
saving the one or more localized subtitles as the one or more localized subtitle tracks within the metadata of the presentation.

15. The method of claim 12, further comprising:
updating the recording of the presentation for rendering the slide with the subtitle.

16. The method of claim 12, further comprising:
detecting a silent section within the audio stream; and
inserting an empty line into the subtitle in a location that corresponds to the silent section within the audio stream.

17. The method of claim 12, further comprising:
detecting an action to display a next slide;
discontinuing a rendering of the slide with the subtitle;
generating a next subtitle for the next slide; and
presenting the next slide with the next subtitle.

18. A computer-readable memory device with instructions stored thereon to provide application based subtitle features for a presentation, the instructions comprising:
receiving an audio stream allocated for a slide of a presentation from a content creator;
generating a subtitle from the audio stream for the slide by converting the audio stream into the subtitle using a speech-to-text scheme;
designating a length of the audio stream as a presentation timing for the subtitle;
integrating the subtitle with the slide based on the presentation timing; and
presenting the slide with the subtitle during the presentation timing in response to a detected action to present the slide.

19. The computer-readable memory device of claim 18, wherein the instructions further comprise:
detecting a background color of the slide; and
selecting a background color for the subtitle, wherein the background color for the subtitle contrasts from the background color of the slide.

20. The computer-readable memory device of claim 18, wherein the instructions further comprise:
detecting a font color of the slide; and
selecting a font color for the subtitle, wherein the font color for the subtitle contrasts from the font color of the slide.
